(19) United States
(12) Patent Application Publication
(10) Pub. No.: US 2010/0303010 A1
(43) Pub. Date: Dec. 2, 2010

(54) CIRCUIT-SWITCHED CALL CONTROL VIA AN IP USER CHANNEL CONNECTION IN THE ACCESS NETWORK

(75) Inventors: Andreas Hochscherff, Bonn (DE); Dieter Jacobsohn, Bonn (DE); Karl-Heinz Nenner, Bornheim (DE)

Correspondence Address: BAKER & DANIELS LLP;111 E. WAYNE STREET, SUITE 800, FORT WAYNE, IN, 46802, US

(73) Assignee: T-MOBILE INTERNATIONAL AG, Bonn (DE)

(21) Appl. No.: 12/682,158

(22) PCT Filed: Oct. 12, 2007
(86) PCT No.: PCT/EP07/08875

§ 371 Date: Jul. 20, 2010

(51) Int. Cl. H04L 12/66; H04W 92/02

(52) U.S. Cl. 370/328; 370/352

(57) ABSTRACT

The invention relates to a method for implementing call control in packet-switched networks, wherein a connection is established between two communications partners by means of static multiplexing in a network and the use of the network for telephone services on an application level, causing signaling between two participating terminal devices. In the course of the general development of the internet, it seems reasonable for operators of conventional telecommunications networks to operate their telephone services via packet-switched networks. However, the establishment of a completely new SIP-based protocol world is disadvantageous for an operator that wishes only to continue its known telephone services. As a result, the operator has the aim of enhancing the transfer of protocols such that the protocols known from circuit-switched technology may be transferred in a simplified fashion to packet-switched networks. Said aim is achieved in that a user channel is configured in the packet-switched access network, wherein call control occurs by means of a circuit-switched signaling via the IP user channel.

The invention concerns a method for realizing telephone services in packet-switched telecommunication networks according to the preamble of claim 1.

Telecommunication networks known from prior art, in which the main application consists of telephone services, such as voice telephony, as well as the associated added-value services, as, for example, call forwarding, use so-called circuit-switched channels to transfer useful information, for example, the language.

Moreover, for such applications special protocols are used which are based on the CCITT signaling system #7 (SS7) for controlling the build-up and relaxation of these user channels.

On this basis, added-value services are performed which use additional logics in the switching nodes or in external nodes of a so-called “intelligent network” (N).

User channels of a circuit-switched network have the characteristic that the bandwidth established during connection buildup has been generally reserved for as long as the connection in the circuit between the caller and the person called exists.

In signaling to control the connections, a difference is made between:
Signaling between the terminal and the network termination point nodes (UNI) in the access network, and
Signaling within the network, i.e., between on-net nodes (NNI), in the communication network.

For example, in ISDN networks the protocol EDSS-1 is used in the access networks and in mobile phone networks according to the GSM standard DTAP is used. In a communication network both networks use ISUP, as well as further protocols from #7 (SS7).

In all above-mentioned cases, dedicated transmission channels are available for signaling, which are managed separate from the user channels, as, for example, for language.

Previously designed data services in circuit-switched networks have been practically completely replaced by packet-switched networks, using Internet-like technologies.

These networks do not establish permanently reserved channels between the communication partners but primarily use a broadband connection via statistical multiplexing together with other data streams.

If such a network is to be used for telephone services, the required signaling is not performed on a network level but on an application level corresponding to Internet pattern. For this reason there are also no dedicated signaling channels for call control.

Instead, call control signaling occurs via the same channels that are used to transmit user data to the application level. In the simplest case, signaling takes place between the terminals concerned, that is, from end-to-end.

Furthermore, communication between the terminals is also possible with the use of an interposed application server to implement additional network control and/or added-value services or the like.

Call control signaling does not distinguish between UNI and NNI in the sense that the same protocol is used in the access network and the communication network.

The solutions currently known and used preferably use the “session initiation protocol” SIP.

It is also possible to use SS7 protocols via IP transport networks (SIGTRAN). However, the present invention does not specifically discuss that this is not in any way related to the invention.

In the course of the general development regarding the Internet, it now seems to be practical also for operators of customary telecommunication networks to handle their telephone services via packet-switched networks, resulting in the fact that circuit-switched networks lose value and that an otherwise required operation of two network infrastructures becomes obsolete.

However, the facts discussed above involve considerable disadvantages to the approach:

The first disadvantage involves the fact that the network operator is required to establish a completely new protocol system based on SIP in order to continue his known telephone services.

A further disadvantage is the new and expensive implementation by means of special application servers of all added-value services based on SIP.

This applies to services currently based on integrated logic in the switching nodes, as well as IN-based services.

In addition, the network is exposed to the attacks from the terminals since an insulation is not provided because of the separation between UNI and NNI.

Moreover, in the context of statistical multiplexing there are no guarantees with regard to connection quality, which, however, is not part of the present invention.

Because of the above-mentioned disadvantages, it is the objective of the invention to develop the transmission of protocols in such a way that the protocols known from circuit-switched technology are transferred as application logs in simplified manner to packet-switched networks.

To achieve this objective, the invention is characterized in that, in the packet-switched access network, a user channel is established on user level in consideration of the access method of a terminal, whereas call control is formed by means of a combination of an IP access network with CS signaling.

Consequently, it is possible for the first time to perform a transmission of call control from a circuit-switched network to packet-switched transmission paths (user channels) in which the realization of telephone services to packet-switched networks, as well as the migration of added-value services from circuit-switched networks to packet-switched networks is being considerably simplified.

In the subsequent description, the abbreviation “CS” (circuit-switched) and “PS” (packet-switched) is used when reference is made to circuit-switched or packet-switched networks. In the following description of the invention, it is also assumed that the PS networks involve IP networks.

However, it should be emphasized that the invention is not restricted to IP networks. Instead, it is possible to use all other PS networks known in prior art to implement telephone services.

Because of the above-mentioned differences between CS and PS with regard to the separation of user channels and signaling channels, which are not available in PS networks, it is required to establish first of all in PS access networks a user channel on the user level in order to make signaling possible on application level.

Said user channel is established in a way that is specific for the access method of the terminals to the PS network, which is not a part of the present invention. For example:
Internet access via landline IISDN/analogous/DSL), whereas, if required, the connection is being initiated by means of a dialing process caused by the terminal via a dedicated gateway;
Mobile networks according to GPRS standard, whereas, if required, the terminal establishes a connection “PDP context” to an external network (for example, Internet);
Future mobile networks, whereas the connection is established by the network upon activation of the terminal.

At best, after an establishment of the access network connection, there exists an end-to-end communication possibility for applications (“IP connectivity” in the case of IP networks) via the connection network, which provides the prerequisite for call control signaling on application level.

It should be emphasized again that in the case of CS networks it is sufficient to connect the circuit from the telephone to the local exchange, whereas in the case of mobile networks the registration of the terminal at the network during the connection process is sufficient to initiate the required signaling connections.

If an outgoing or incoming call from/to the terminal should be signaled, the signaling does not take place via SIP—as is customary in IP networks—but, according to the invention, via an IP channel (contrary to customary CS technology), using the signaling DTAP known from CS technology.

Currently, there is IP network technology, as well as CS call control signaling in existence.

New in the sense of the invention is a combination of IP access networks and CS signaling.

The invention-based combination has the following advantages:
1. The available CS signaling in the terminals can still be used; it is only required to make an adjustment to the PS transmission channel. This means that it is necessary to specify the existing CS signaling DTAP as an IP application.
2. Accordingly, on the network side, the available CS signaling is maintained at the network termination point nodes. Because of the still identical call control, all services implemented in the CS nodes are automatically available in the PS network, without further interference.
3. Based on the above-mentioned advantages, it is also possible to immediately transfer services to the IP network, whereas the services are implemented by means of an IN. The available interaction of the network termination point nodes with the IN can be used with minimal effort of adaptation.
4. By maintaining the DTAP signaling and its termination in the network termination point nodes, it is possible to preserve the UNI/NNI separation. Consequently, the principle of insulating the network toward the terminal continues to apply, i.e., the terminal is only exposed to the network termination point node and no further network nodes.
5. The network termination point node with its current call control function is basically maintained. Therefore, in terms of signaling, interworking with existing CS networks is possible.
6. The available accounting technologies and methods for the calls remain unchanged. Presently, these are based on “call detail records” (CDR), which are generated in the MSC or the landline switching node on the basis of call control signaling. Because of maintaining call control signaling, they can also be generated in the invention-based network termination point node.

Contrary to CS networks, the user channel communication does not pass through the network termination point node but the above-mentioned dial-up node (“gateway”), for example, the GGSN in GPRS networks.

In principle the network termination point node required here involves a kind of MSC. However, in contrast to known MSCs, these are:
Restricted to signaling functions,
Having CS signaling based on standard IP networks,
Placed inside the communication network, from the aspect of the IP access network outside of the network.

The separation between signaling and user channels described in the present invention makes it possible—together with an accessibility of all nodes by means of all other nodes and terminals which is directly possible in IP networks—to centralize the network termination point nodes in the communication network and process on-net calls using only one network termination point node. This means that it is not required to permanently assign network termination point nodes to regional or organizational access network areas, for example, the coverage area of a local exchange or a specific radio coverage area of the mobile network.

The same applies to the requirement of 2 MSCs in one call (originating and terminating MSC).

For a better understanding of the invention, said network termination point node is subsequently called “pseudo MSC,” because it comprises merely the call control function of one customary MSC. However, from an aspect of the access network and terminal (UN), on the one hand, and the communication network (NNI), on the other hand, in terms of signaling it is represented like an MSC.

In this context, it should be emphasized that with regard to call control signaling the present invention corresponds largely to the Rel-4 CS architecture of 3GPP.

However, the network termination point node “pseudo MSC” comprises merely the call control function and no other functions of an MSC/VLR. Furthermore, contrary to the Rel-4 MSC server, it works together with an actual IP access network, such as, GPRS or DSL.

After by means of call control signaling the user data connection has been established, the terminals can use the IP connection in the access network used for signaling also for the transfer of user data.

However, if the connection through IP filter cannot be used for user data, it is first of all necessary to arrange for a respective initiation of the channel through the pseudo MSC.

Alternatively, it is possible to provide a special channel for the user connection in IP networks which support several “IP channels” per terminal, such as, GPRS with several simultaneous PDP contexts.

This type of control of user channels in the PS dial-up node by means of the pseudo MSC can be performed, for example, through “policy control” solutions in 3GPP standard, in which the gateway is assigned to admit an existing channel for user data transmission, or to provide for the user channel an IP channel of specific quality for the user data packets recorded by means of a filter.

In the communication network, on the other hand, communication between the two gateways can be performed without further technical measures because of the technical characteristics of an IP communication network.

The subject matter of the present invention does not only consist of the subject matter of each individual claim, but results from an interchange of the individual claims.

Subsequently, the invention is described in more detail by means of a drawing which depicts merely one particular form of implementation. The drawing and its description disclose further essential characteristics and advantages of the invention.

It is shown:

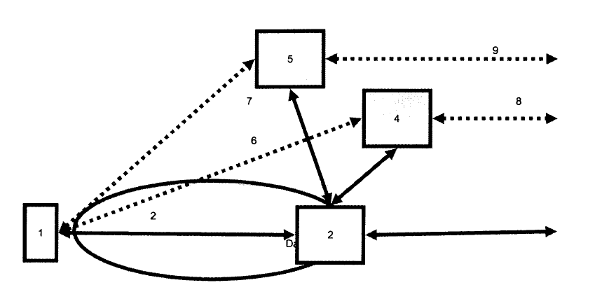

FIG. 1: a diagram of the invention-based call control in packet-switched networks

The diagram depicted in FIG. 1 shows an invention-based solution for implementing telephone services in a packet-switched network.

An access network extends, for example, from the GPRS network to the GGSN in future mobile networks or a DSL-based access network 2 in a landline.

The network termination point node for call signaling—the pseudo MSC 5—is not located inside the access network 2, as is customary in CS mobile networks but, from the aspect of the access network 2, in an external network.

Communication between the pseudo MSC 5 and the on-net signaling nodes (NNI) takes place by means of currently known technology—further embodiments with regard to possible scenario are subsequently described in more detail.

### 1. Description of the Signaling Functions

In this context, it should be emphasized that in all subsequently described cases the user channels are provided in the IP access and communication network, as described above.

### 1.1 Call Establishment Outgoing:

Signaling of the call establishment occurs on the initiative of the mobile terminal 1 with the known DTAP messages using the telephone number of the person called. As shown in the diagram, said signaling occurs via the IP user channel provided by the access network 2 to the—from the aspect of the access network 2—external network termination point node pseudo MSC 5. Further signaling inside the communication network (NNI) is described in more detail in the following scenarios.

1.2 Call establishment incoming:

Here signaling to the mobile terminal 1 is also performed with the known DTAP procedures whereas also in this case a signaling connection via the IP user channel provided by the access network exists between the person called and the pseudo MSC 5.

Alternatively, a new message can be defined by means of which in case of an incoming call the pseudo MSC 5 requests the terminal 1 to perform outgoing call signaling in order to establish the user data connection. This outgoing call establishment request is then assigned in the pseudo MSC 5 to the available incoming call and—controlled by the pseudo MSC 5—the user channels in the gateway are connected respectively.

1.3 Call establishment end-to-end:

1.3.1 On-net

The central component of the invention is the pseudo MSC 5, which provides currently known call control and signaling via an IP network.

Since the mobile terminal 1 of the caller, as well as that of the person called are able to achieve the same pseudo MSC 5 if the caller and the person called are in the same network, it is basically never required to use two pseudo MSCs 5 (originating and terminating), but each call is processed with only one pseudo MSC 5.

Initially, the call establishment occurs through the caller, as described above. Too find the person called is now restricted to finding by means of the pseudo MSC 5 the network address of the person called. To unlock the called telephone number to the IP

address of the person called, possible solutions are already available and will not be described in detail.

As soon as the IP address has been found, the incoming call establishment to the person called takes place as described above.

In addition, it should be emphasized that it is certainly also possible to use several pseudo MSCs 5, as described in 1.1 in a case across the network, whereas here the function “finding of the destination network” does not apply.

1.3.2 Across the network

If the caller and the person called are not in the same network, it can be assumed that a pseudo MSC 5 is used in the network of the caller (“originating”), as well as in the network of the person called (“terminating”). Also in this case, it is technically possible that call control takes place through only one pseudo MSC 5, for example, the MSC5 in the network of the caller. However, for reasons of—desired—organizational and technical network separation, network operators do not allow such call control. In addition, the use of one pseudo MSC 5, respectively, in both networks provides the possibility to generate CDRs in the network of the caller, as well as in the network of the person called.

Call establishment on the part of the caller occurs now in the manner described above. Finding the destination network (the network of the person called), as well as routing call establishment signaling takes place by means of functions currently used in CS networks, on the basis of the telephone number the caller used for the person called.

Furthermore, the gateway MSC in the destination network must include the function of the pseudo MSC 5 and must recognize the incoming call establishment as belonging to the scenario described instead of a “normal” CS call.

Thereafter, the IP address of the person called is determined and the incoming call establishment request is transferred as described under 1.3.1.

1.3.4 Interworking with CS

If an outgoing call comes into an existing CS network (mobile network or landline), the signaling processes are identical with 1.1 or 1.3.1.

The IP user channel is now transferred to a normal CS user channel in the direction of a CS destination network.

For this purpose, a media gateway is required, whereas respective solutions for such transfer are prior art standard and are not discussed in detail in this context.

Consequently, there exists a CS signaling and user channel in the direction of the CS destination network which can be processed there.

If an incoming call emerges from an existing CS network, it is first of all displayed on the gateway MSC. The gateway MSC routes the call to the terminating MSC, using the functions available in mobile networks.

This terminating MSC now has the function of a media gateway of transferring the incoming CS user channel to CS, as well as a pseudo MSC 5, in order to process DTAP signaling via IP or to interact with such nodes.

Alternatively, this function is also immediately available in the gateway MSC. At this point, a PS signaling and user channel is available which is used for further processing as described under 1.2 and 1.3.1.

1.3.5 Interworking with SIP-based networks

In the event of outgoing or incoming calls into or from an SIP-based IP network, a transfer of the signaling between CS and PS is required at the network termination point nodes, while the PS user channel is maintained.

Said transfer can be performed with the use of available SS7/SIP interworking solutions. Since in the SIP-based network, as well as in the non-SIP-based IP network the user channel directly attaches to IP channels, no further measures for interworking are required.

However, sometimes it is expedient to use a transcoding function in the network, if provision has been made to use different codes at the terminals involved in communication.

All statements and characteristics disclosed in the documents, including the abstract, in particular the spatial layout shown in the drawings, are claimed to be an essential part of the invention, provided they are individually or in combination new compared to prior art.

### REFERENCE LIST

1. Terminal
2. Constraint network
3. Transport channel
4. IMS (IP multimedia subsystem)
5. Pseudo MSC (pseudo—message sequence chart)
6. SIP (session initiation protocol)
7. DTAP (direct transfer application part (GSM)
8. SIP (session initiation protocol)

### LEGEND

NNI: on-net signaling node
UNI: network point node
Multiplexing: transfer of pooled data
IN: intelligent network
INS: integrated network system
ISDN: integrated services digital network
DSL: digital subscriber line
GSM: global system mobile
ISUP: ISDN user part
IP: Internet protocol
CS: circuit-switched
PS: packet-switched
GGSN: gateway GPRS support node
GPRS: general packet radio service
PDP context: packet data protocol context
CDR: call detail record

1. A method for realizing call control in packet-switched telecommunication networks, in which a connection is formed between two communication partners in a network via statistical multiplexing (transfer of pooled data) and the use of the network for telephone services is performed on a level which forms a signaling between two involved terminals, whereas in a packet-switched access network (2), a user channel is established on user level in consideration of the access method of a terminal (1), whereas call control is formed by means of a combination of an IP access network (2) with CS signaling, characterized in that a separation is performed of signaling and user channels, in which the signaling and call control function takes place through a network termination point node in form of a Pseudo-MSC, and the user channel communication passes through a dial-up node, gateway, whereas the network termination-point node is restricted to a signaling function with, works on standard IP network attachable CS-Signaling protocol and is placed network-external within the communication network, from the aspect of the IP-access network.

2. A method according to claim 1, characterized in that the available CS signaling can be used in the terminals, requiring an adjustment to the PS transmission channel, which specifies the existing CS signaling DTAP as an IP application.

3. A method according to claim 1, characterized in that, on the network side, the available CS signaling is maintained at the network termination point nodes whereas, because of the still identical call control, all services implemented in the CS nodes are automatically available in the access network (2).

4. A method according to claim 1, characterized in that, on the basis of the available services in the access network (2), it is possible to form an immediate transfer of services to the IP network, whereas the services are implemented via an intelligent network, in which the available interaction if the network termination point nodes with the intelligent network prevents the effort of adaptation.

5. A method according to claim 1, characterized in that, because of maintaining DTAP signaling and its termination, a UNI/NNI separation is formed in the network termination point node, whereas the separation forms an insulation toward the terminal, whereas the terminal merely detects the network termination point node.

6. A method according to claim 1, characterized in that available accounting technologies and methods for the calls remain unchanged, whereas the accounting method is performed by means of “call detail records” (CDR), which are generated in the MSC or the landline switching node on the basis of call control signaling and can also be generated in the network termination point node because call control signaling is maintained.

7. A method according to claim 1, characterized in that the access network (2) is preferably formed between a GPRS network and a DSL based access network or a future mobile network, whereas the network termination point node for call signaling is designed as pseudo MSC (5) in an access network (2) of an external network.

8. A method according to claim 1, characterized in that the signaling process comprises the following procedural steps:
Signaling the call establishment of a terminal to an external pseudo MSC (5) by means of DTAP messages via an IP user channel provided by the access network (2);
Establishing a signaling connection of an incoming call establishment from the pseudo MSC (5) to a mobile terminal (1) via the IP user channel provided by the access network (2), in which a new message can be defined which requests the terminal (1) to perform an outgoing call signaling to establish the user data connection (5);
Call establishment of two terminals (1) in the same network (on-net), which terminals (1) achieve the same pseudo MSC (5), in which the pseudo MSC (5) performs merely the finding of the network address of the person called;
Call establishment of two terminals (1) in different networks (network transcending), in which both networks comprise a pseudo MSC (5) or the call establishment can be performed by means of the mutual utilization of the pseudo MSC (5) of one of the networks, whereas the gateway MSC in the network of the person called also comprises the function of the pseudo MSC (5) and recognizes and assigns the incoming call establishment.
Call establishment to an existing CS network (mobile network or landline), whereas the IP user channel (2) in the direction of the CS destination network is transferred via a media gateway to a normal CS user channel and forms a CS signaling and user channel;
Call establishment to or from an SIP-based IP network, whereas a transfer of signaling between CS and PS is designed at the network termination point nodes, while the PS user channel is maintained.

9. A method according to claim 2, characterized in that, on the network side, the available CS signaling is maintained at the network termination point nodes whereas, because of the still identical call control, all services implemented in the CS nodes are automatically available in the access network (2).

10. A method according to claim 2, characterized in that, on the basis of the available services in the access network (2), it is possible to form an immediate transfer of services to the IP network, whereas the services are implemented via an intelligent network, in which the available interaction if the network termination point nodes with the intelligent network prevents the effort of adaptation.

11. A method according to claim 2, characterized in that, because of maintaining DTAP signaling and its termination, a UNI/NNI separation is formed in the network termination point node, whereas the separation forms an insulation toward the terminal, whereas the terminal merely detects the network termination point node.

12. A method according to claim 2, characterized in that available accounting technologies and methods for the calls remain unchanged, whereas the accounting method is performed by means of “call detail records” (CDR), which are generated in the MSC or the landline switching node on the basis of call control signaling and can also be generated in the network termination point node because call control signaling is maintained.

13. A method according to claim 2, characterized in that the access network (2) is preferably formed between a GPRS network and a DSL based access network or a future mobile network, whereas the network termination point node for call signaling is designed as pseudo MSC (5) in an access network (2) of an external network.

14. A method according to claim 2, characterized in that the signaling process comprises the following procedural steps:
Signaling the call establishment of a terminal to an external pseudo MSC (5) by means of DTAP messages via an IP user channel provided by the access network (2);
Establishing a signaling connection of an incoming call establishment from the pseudo MSC (5) to a mobile terminal (1) via the IP user channel provided by the access network (2), in which a new message can be defined which requests the terminal (1) to perform an outgoing call signaling to establish the user data connection (5);
Call establishment of two terminals (1) in the same network (on-net), which terminals (1) achieve the same pseudo MSC (5), in which the pseudo MSC (5) performs merely the finding of the network address of the person called;
Call establishment of two terminals (1) in different networks (network transcending), in which both networks comprise a pseudo MSC (5) or the call establishment can be performed by means of the mutual utilization of the pseudo MSC (5) of one of the networks, whereas the gateway MSC in the network of the person called also comprises the function of the pseudo MSC (5) and recognizes and assigns the incoming call establishment.
Call establishment to an existing CS network (mobile network or landline), whereas the IP user channel (2) in the direction of the CS destination network is transferred via a media gateway to a normal CS user channel and forms a CS signaling and user channel;
Call establishment to or from an SIP-based IP network, whereas a transfer of signaling between CS and PS is designed at the network termination point nodes, while the PS user channel is maintained.
